(19) United States
(12) Patent Application Publication
(10) Pub. No.: US 2021/0347986 A1
(43) Pub. Date: Nov. 11, 2021

(54) UNCOATING METALLIC THERMOPLASTIC RESIN COMPOSITION AND MOLDED ARTICLE THEREOF

(71) Applicants: Hyundai Motor Company, Seoul (KR); Kia Motors Corporation, Seoul (KR); Samyang Corporation, Seoul (KR)

(72) Inventors: Kyeong Hoon Jang, Seoul (KR); In Soo Han, Uiwang (KR); Seul Yi, Seoul (KR); Jae Hyun An, Seosan (KR); Dae Sik Kim, Yongin (KR); Si Uk Cheon, Daejeon (KR); Chul Jin Jo, Daejeon (KR); Jung Kyu Han, Sejong (KR); Tae Jin An, Daejeon (KR); Hyung Jin Roh, Daejeon (KR); Suk Woo Kang, Wonju (KR); Do Young Bae, Daejoen (KR)

(21) Appl. No.: 17/036,822

(22) Filed: Sep. 29, 2020

(30) Foreign Application Priority Data
May 11, 2020 (KR) 10-2020-0055973

(51) Int. Cl. C08L 69/00

(52) U.S. Cl. CPC C08L 69/00; C08L 2205/035

(57) ABSTRACT

Disclosed are an uncoating metallic thermoplastic resin composition invention including metallic particles at an appropriate ratio and a molded article including the same. The molded article may maintain the mechanical properties such as impact strength and fluidity at an excellent level as well as improving the appearance characteristics such as luminance characteristics (high luminance) and metallic texture. The uncoating metallic thermoplastic resin composition and the molded article thereof may be usefully applied to the molded products in fields where the characteristics of the appearance quality are importantly required, for example, cell phone housing, TV housing, computer monitor housing, automobile bumper, wheel housing, panel button portion, interior and exterior lighting lamp housings, and the like.

### CROSS-REFERENCE TO RELATED APPLICATION

### Technical Field

The present invention relates to an uncoating metallic thermoplastic resin composition having improved metallic texture and high luminance including metallic particles and a molded article thereof.

### Background

Recently, plastic interior and exterior products in which various colors are implemented have been popular in electric and electronic components and vehicle components, and there has been also an increasing demand for a metallic material which may give a more luxurious metallic texture.

Such plastic interior and exterior products mainly exhibit the metallic texture on the exterior of the product by coating a plastic resin molded article with the paint containing metallic particles. However, a post-processing such as coating for exhibiting the metallic texture causes an increase in the manufacturing cost due to difficulties in masking, defects, and handling, and also is harmful to the human body and the environment by using volatile organic compounds.

Accordingly, in recent years, the plastic interior and exterior products mainly tend to exhibit the metallic texture on the exterior of the product by adding metallic particles or the like to the plastic resin. However, a method for producing a molded article by simply adding the metallic particles to a plastic resin has a limit to improving the metallic texture of the molded article due to the reduction in a reflective area of light formed as the exterior of the molded article because of a problem in that the metallic particles sufficiently exhibit on a surface. Moreover, the method may give the feeling of mixing metal to resin but disparity with the painted product exhibiting the metallic texture is not avoidable, such that the molded article is not sufficient to function as an uncoating product which may replace the painted product.

Further, in order to improve these limitations, a method for double-injecting or extruding the metallic layer to the molded article has been reported. However, in that method, the processing cost is increased by the double processing and the pre-processing work thereof and the degree of freedom for the product design is significantly limited.

Accordingly, there is a need for an uncoating metallic thermoplastic resin composition capable of maintaining excellent impact strength and fluidity even while improving luminance characteristics and having the metallic texture like the painted product.

The above information disclosed in this Background section is only for enhancement of understanding of the background of the invention and accordingly it may contain information that does not form the prior art that is already known in this country to a person of ordinary skill in the art.

### SUMMARY

In preferred aspect, provided is an uncoating metallic thermoplastic resin composition including an impact reinforcing agent such as a polycarbonate resin; a polyester resin; a core-shell graft copolymer, and an ethylene-acrylic mixed resin; and metallic particles and a molded article including the same.

The term “uncoating composition” as used herein refers to a composition that is not suitably made for a coating method or coating process. The uncoating composition may be included in a product as a component constituting a body of the product, not as a coated component. For example, the uncoating composition may be processed (e.g., melt by heat or pressure, injected or extruded) to form a molded product.

The object of the present invention is not limited to the aforementioned object. The object of the present invention will be more apparent from the following description, and will be realized by means described in the claims and combinations thereof.

In an aspect, provided is an uncoating metallic thermoplastic resin composition (or “composition”) including an amount of about 20 to 80% by weight of a polycarbonate resin, an amount of about 5 to 50% by weight of a polyester resin, an amount of about 5 to 20% by weight of an impact reinforcing agent, and an amount of about 0.1 to 10% by weight of a metallic particle, based on the total weight of the uncoating metallic thermoplastic resin composition.

The impact reinforcing agent may include one or more selected from a core-shell graft copolymer and an ethylene-acrylic mixed resin.

The polycarbonate resin may suitably have a viscosity average molecular weight (Mv) of about 15,000 to 40,000 (25° C. methylene chloride solution).

The polyester resin may suitably have an intrinsic viscosity [η] of about 0.85 to 1.52 dl/g.

The core-shell graft copolymer may include one or more monomers selected from unsaturated compounds consisting of C1-C8 methacrylic acid alkyl esters, C1-C8 methacrylic acid esters, maleic anhydride, and C1-C4 alkyl or phenyl nuclear-substituted maleimides with a core of rubber-based polymer which is manufactured by polymerizing at least one type selected from the group consisting of a C4-C6 diene-based rubber, an acrylate-based rubber, and a silicone-based rubber monomer. For example, the core-shell graft copolymer may be formed by graft-copolymerizing one or more monomers selected from unsaturated compounds consisting of C1-C8 methacrylic acid alkyl esters, C1-C8 methacrylic acid esters, maleic anhydride, and C1-C4 alkyl or phenyl nuclear-substituted maleimides with a core of rubber-based polymer which is manufactured by polymerizing at least one type selected from the group consisting of a C4-C6 diene-based rubber, an acrylate-based rubber, and a silicone-based rubber monomer.

The ethylene-acrylic mixed resin may suitably include an amount of about 15 to 40% by weight of an acrylic-based resin, and an amount of about 60 to 85% by weight of an ethylene, based on 100% by weight of the ethylene-acrylic mixed resin.

The impact reinforcing agent may suitably include the ethylene-acrylic mixed resin:the core-shell graft copolymer at a weight ratio of about 1:0.4 to 10.

The metallic particle may suitably include one or more selected from the group consisting of aluminum and an aluminum-based alloy.

An average particle diameter of the metallic particle may be of about 5 to 100 μm.

The metallic particle may suitably include one or more selected from the group consisting of a first metallic particle which has the average particle diameter of about 5 μm or greater and less than about 10 μm, and a second metallic particle which has the average particle diameter of about 10 to 100 μm.

The metallic particle may contain the first metallic particle: the second metallic particle at a weight ratio of about 1:0.3 to 10.

The uncoating metallic thermoplastic resin composition may include one or more selected from the group consisting of flame retardants, antioxidants, lubricants, release agents, nucleating agents, dispersants, antistatic agents, ultraviolet (UV) stabilizers, pigments, and dyes.

In an aspect, provided is a molded article that may include the uncoating metallic thermoplastic resin composition as described herein.

The uncoating metallic thermoplastic resin composition may include metallic particles at an appropriate ratio, such that the molded article made of the composition may maintain the mechanical properties such as impact strength and fluidity at an excellent level as well as improving the appearance characteristics such as luminance characteristics (high luminance) and metallic texture. Accordingly, the uncoating metallic thermoplastic resin composition and the molded article thereof may be usefully applied to the molded products in fields where the characteristics of the appearance quality are importantly required, for example, a cell phone housing, a TV housing, computer monitor housing, an automobile bumper, a wheel housing, a panel button portion, interior and exterior lighting lamp housings, and the like.

The effects of the present invention are not limited to the aforementioned effects. It should be understood that the effects of the present invention include all effects which may be inferred from the following description.

The other aspects of the invention are discussed infra.

### DETAILED DESCRIPTION

As described above, objects, other objects, features, and advantages according to the present invention will be readily understood through the following preferred Examples associated with the accompanying drawings. However, the present invention is not limited to the Examples described herein and may also be embodied in other forms. Rather, the Examples introduced herein are provided so that the invention may be made thorough and complete, and the spirit according to the present invention may be sufficiently conveyed to those skilled in the art.

In this specification, it should be understood that terms such as “comprise” or “have” are intended to indicate that there is a feature, a number, a step, an operation, a component, a part, or a combination thereof described on the specification, and do not exclude the possibility of the presence or the addition of one or more other features, numbers, steps, operations, components, parts, or combinations thereof in advance.

Unless otherwise indicated, all numbers, values, and/or expressions referring to quantities of ingredients, reaction conditions, polymer compositions, and formulations used herein are to be understood as modified in all instances by the term “about” as such numbers are inherently approximations that are reflective of, among other things, the various uncertainties of measurement encountered in obtaining such values. Further, where a numerical range is disclosed herein, such a range is continuous, and includes unless otherwise indicated, every value from the minimum value to and including the maximum value of such a range. Still further, where such a range refers to integers, unless otherwise indicated, every integer from the minimum value to and including the maximum value is included.

Unless otherwise indicated, all numbers, values, and/or expressions referring to quantities of ingredients, reaction conditions, polymer compositions, and formulations used herein are to be understood as modified in all instances by the term “about” as such numbers are inherently approximations that are reflective of, among other things, the various uncertainties of measurement encountered in obtaining such values.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In the present specification, if a range is described for a variable, it will be understood that the variable includes all values within the described range including the described endpoints of the range. For example, it will be understood that a range of “5 to 10” includes not only values of 5, 6, 7, 8, 9, and 10 but also any sub-range such as 6 to 10, 7 to 10, 6 to 9, and 7 to 9, and also includes any value between reasonable integers within the scope of the described ranges such as 5.5, 6.5, 7.5, 5.5 to 8.5, 6.5 to 9, and the like. Further, it will be understood that a range of “10% to 30%” includes, for example, not only all integers including values, such as 10%, 11%, 12%, and 13%, and up to 30% but also any sub-range such as 10% to 15%, 12% to 18%, and 20% to 30%, and also includes any value between reasonable integers within the scope of the described range, such as 10.5%, 15.5%, and 25.5%.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Uncoating Metallic Thermoplastic Resin Composition

In the present specification, the uncoating metallic thermoplastic resin composition is not particularly limited as long as it is a composition capable of configuring an external component which has improved luminance characteristics and metallic texture even without degrading properties even in an environment such as oxygen, ozone, or ultraviolet rays between vehicle components.

In an aspect, provided is an uncoating metallic thermoplastic resin composition including a polycarbonate resin polyester resin, an impact reinforcing agent, and metallic particles. Preferably, the uncoating metallic thermoplastic resin composition may include an amount of about 20 to 80% by weight of a polycarbonate resin, an amount of about 5 to 50% by weight of a polyester resin, an amount of about 5 to 20% by weight of an impact reinforcing agent, and an amount of about 0.1 to 10% by weight of metallic particles. The % by weights are based on the total weight of the uncoating metallic thermoplastic resin composition.

(1) Polycarbonate Resin

The polycarbonate resin is not particularly limited as long as it may be used with the polyester resin, thereby improving moldability even while improving mechanical properties such as impact strength and tensile strength of a molded article containing the same.

The polycarbonate resin may contain, as a thermoplastic aromatic polycarbonate, one or more selected from the group consisting of a linear polycarbonate resin, a branched polycarbonate resin, a polyester-carbonate resin, and a copolycarbonate copolymerized with a silicone-based resin.

For example, the thermoplastic aromatic polycarbonate may be made of a divalent phenol, a carbonate precursor, and a molecular weight regulator. The divalent phenols may be, for example, a monomer of a polycarbonate resin having a structure of Formula 1 below.

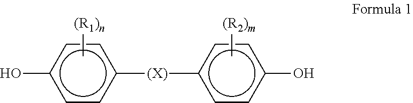

In Formula 1, X refers to an alkylene group, which is a straight, branched, or cyclic alkylene group having no functional group; or a straight, branched, or cyclic alkylene group containing a functional group such as sulfide, ether, sulfoxide, sulfone, ketone, naphthyl, or isobutylphenyl. For example, X may be a linear or branched alkylene group having 1 to 10 carbon atoms, or a cyclic alkylene group having 3 to 6 carbon atoms. Further, each of R₁ and R₂ may be independently a hydrogen atom, a halogen atom, or an alkyl group, for example, a linear or branched alkyl group having 1 to 20 carbon atoms, or a cyclic alkyl group having 3 to 20 (preferably, 3 to 6) carbon atoms. Further, n and m may be independently an integer of 0 to 4.

The divalent phenol may contain a common divalent phenol, for example, a bisphenol A, a bis (4-hydroxyphenyl) methane, a bis (4-hydroxyphenyl) phenylmethane, a bis (4-hydroxyphenyl) naphthylmethane, a bis (4-hydroxyphenyl)-(4-isobutylphenyl) methane, a 1,1-bis (4-hydroxyphenyl) ethane, a 1-ethyl-1,1-bis (4-hydroxyphenyl) propane, a 1-phenyl-1,1-bis (4-hydroxyphenyl) ethane, a 1-naphthyl-1,1-bis (4-hydroxyphenyl) ethane, a 1,2-bis (4-hydroxyphenyl) ethane, a 1,10-bis (4-hydroxyphenyl) decane, a 2-methyl-1,1-bis (4-hydroxyphenyl) propane, a 2,2-bis (4-hydroxyphenyl) propane (bisphenol A), or the like, and is not limited to containing a specific component, but may preferably be a bisphenol A.

The carbonate precursor may be a monomer of the polycarbonate resin, and may include a common precursor, for example, a phosgene (carbonyl chloride), a carbonyl bromide, a bis halo formate, a diphenyl carbonate or a dimethyl carbonate, or the like, and is not limited to containing a specific component, but preferably, may be a phosgene (carbonyl chloride).

The molecular weight regulator may be a monofunctional compound similar to the monomer used in manufacturing the thermoplastic aromatic polycarbonate resin, and may be a common molecular weight regulator, for example, as derivatives based on a phenol, a para-tert-butylphenol, a para-isopropylphenol, a para-cumylphenol, a para-isooctylphenol, a para-isononylphenol, or the like. The molecular weight regulator may also include various types of materials such as aliphatic alcohols, and is not limited to including a specific component, but preferably, may be a para-tert-butylphenol (PTBP) having excellent thermal stability.

The polycarbonate resin may suitably have a viscosity average molecular weight (Mv) measured in a methylene chloride solution of about 15,000 to 40,000, or particularly may have the viscosity average molecular weight of about 17,000 to 30,000. When the viscosity average molecular weight is less than about 15,000, mechanical properties such as impact strength and tensile strength may be degraded, and when the viscosity average molecular weight is greater than about 40,000, a problem may occur in the processing of the resin due to an increase in melt viscosity. Particularly, the viscosity average molecular weight may be about 19,000 or greater in that the mechanical properties such as impact strength and tensile strength are excellent, and the viscosity average molecular weight may be about 30,000 or less in view of processability.

The content of the polycarbonate resin may be an amount of about 20 to 80% by weight based on 100% by weight of the uncoating metallic thermoplastic resin composition, of about 30 to 70% by weight thereof, or particularly of about 40 to 70% by weight thereof. When the content is less than about 20% by weight, the heat resistance and the mechanical properties may be poor, and when the content is greater than about 80% by weight, the moldability such as injection processability may decrease.

(2) Polyester Resin

The polyester resin a is not particularly limited as long as it may be used with the polycarbonate resin, thereby improving moldability even while improving mechanical properties such as heat resistance and impact resistance of a molded article containing the same.

The polyester resin may be a resin poly-condensed by melt polymerization from a terephthalic acid or a terephthalic acid alkyl ester, and a glycol having 2 to 10 carbon atoms, as an aromatic polyester resin. At this time, the alkyl means alkyl having 1 to 10 carbon atoms. The aromatic polyester resin may include a typical resin, for example, a polyethylene terephthalate resin, a polytrimethylene terephthalate resin, a polybutylene terephthalate resin, a polyhexamethylene terephthalate resin, a polycyclohexane dimethylene terephthalate resin, or a polyester resin which is amorphously modified by mixing some other monomers with these resins, and is not limited to containing a specific component. The aromatic polyester resin may suitably include a polybutylene terephthalate resin, a polyethylene terephthalate resin, a polytrimethylene terephthalate resin, an amorphous polyethylene terephthalate resin, or the like, or particularly, may be a polybutylene terephthalate resin having excellent injection processability. The polybutylene terephthalate as a monomer may include a polymer obtained by poly-condensing a 1,4-butanediol and a terephthalic acid or dimethyl terephthalate by directly performing an esterification reaction or transesterification reaction. Further, in order to increase the impact strength of the resin, the polybutylene terephthalate may also be used by copolymerizing the polybutylene terephthalate with a polytetramethylene glycol (PTMG), a polyethylene glycol (PEG), a polypropylene glycol (PPG), a low molecular weight aliphatic polyester or aliphatic polyamide, or may be used in the form of a modified polybutylene terephthalate mixed with an impact enhancing component.

In the polyester resin according to the present invention, an intrinsic viscosity [η] is measured at a temperature of 25° C. o-chlorophenol solution condition and may be about 0.85 to 1.52 dl/g, or particularly of about 1.03 to 1.22 dl/g. The intrinsic viscosity of the polyester resin may be required to be within the above range to secure excellent mechanical properties and moldability, and when the intrinsic viscosity [η] is less than about 0.85 dl/g, chemical resistance may decrease and heat resistance may decrease, and when the intrinsic viscosity [η] is greater than about 1.52 dl/g, injection moldability may decrease.

The content of the polyester resin may be about 5 to 50% by weight based on 100% by weight of the uncoating metallic thermoplastic resin composition, of about 10 to 40% by weight, or particularly of about 20 to 40% by weight. When the content is less than about 5% by weight, the injection moldability and chemical resistance may decrease, and when the content is greater than about 50% by weight, the mechanical properties may decrease and the heat resistance may decrease.

(3) Impact Reinforcing Agent

The impact reinforcing agent is not particularly limited as long as it may improve compatibility and impact strength of a molded article containing the same.

The impact reinforcing agent may be an amount of about 5 to 20% by weight based on 100% by weight of the uncoating metallic thermoplastic resin composition. When the content is less than about 5% by weight, the impact strength may not be sufficient, and when the content is greater than about 20% by weight, gas may be generated and product surface quality may be degraded.

The impact reinforcing agent may include one or more selected from a core-shell graft copolymer and an ethylene-acrylic mixed resin. A detailed description thereof is as follows.

(3-1) Core-Shell Graft Copolymer

The core-shell graft copolymer may be a structure which is formed of a hard shell because a vinyl monomer is graft-copolymerized with a core structure of rubber. For example, the core-shell graft copolymer may be manufactured by graft-copolymerizing one or more monomers selected from unsaturated compounds consisting of C1-C8 methacrylic acid alkyl esters, C1-C8 methacrylic acid esters, maleic anhydride, and C1-C4 alkyl or phenyl nuclear-substituted maleimides with a core of rubber-based polymer which is manufactured by polymerizing at least one type selected from the group consisting of a C4-C6 diene-based rubber, an acrylate-based rubber, and a silicone-based rubber monomer.

The diene-based rubber may be a conventional diene-based rubber, for example, a butadiene rubber, an acrylic rubber, an ethylene/propylene rubber, a styrene/butadiene rubber, an acrylonitrile/butadiene rubber, an isoprene rubber, an ethylene-propylene-diene terpolymer (EPDM), or the like, and is not limited to containing a specific component.

The acrylate-based rubber may include a common acrylate-based rubber, for example, an acrylate monomer, such as a methyl acrylate, an ethyl acrylate, an n-propyl acrylate, an n-butyl acrylate, a 2-ethylhexyl acrylate, a hexyl methacrylate, or a 2-ethylhexyl methacrylate, or the like, and is not limited to containing a specific component. The curing agent for the acrylate-based rubber may include an ethylene glycol dimethacrylate, a propylene glycol dimethacrylate, a 1,3-butylene glycol dimethacrylate or a 1,4-butylene glycol dimethacrylate, an allyl methacrylate, a tri allyl cyanurate or the like.

The silicone-based rubber may be manufactured from a cyclosiloxane, and examples, may include a hexamethylcyclotrisiloxane, an octamethylcyclotetrasiloxane, a decamethylcyclopentasiloxane, a dodecamethylcyclohexasiloxane, a trimethyltriphenylcyclotrisiloxane, a tetramethyltetraphenylcyclotetrosiloxane, an octaphenylcyclotetrasiloxane, or the like, and is not limited to containing a specific component. The curing agent for the silicone-based rubber may be a trimethoxymethylsilane, a triethoxyphenylsilane, a tetramethoxysilane, a tetraethoxysilane, or the like.

By using a silicone rubber or a mixture of a silicone-based rubber and an acrylate-based rubber, better effects may be obtained in chemical resistance and thermal stability due to structural stability.

The C1-C8 methacrylic acid alkyl esters, or the C1-C8 acrylic acid alkyl esters may be esters manufactured from monohydryl alcohols having 1 to 8 carbon atoms, as esters of a methacrylic acid or an acrylic acid, respectively, and specific examples may be a methacrylic acid methyl ester, a methacrylic acid ethyl ester, a methacrylic acid propyl ester, or the like, but are not limited to containing a specific component, but preferably, may be a methacrylic acid methyl ester having excellent compatibility.

The impact reinforcing agent may include an ethylene-acrylic mixed resin: core-shell graft copolymer at a weight ratio of about 1:0.4 to 10. The content of the core-shell graft copolymer may be about 4 to 10% by weight based on 100% by weight of the uncoating metallic thermoplastic resin composition, or particularly of about 4 to 8% by weight. When the content is less than 4% by weight, the effect of impact reinforcing may not be sufficient, such that it is difficult to implement excellent uncoated impact characteristics, and when the content is greater than about 10% by weight, thermal stability, and appearance characteristics due to gas, and the like may be degraded.

(3-2) Ethylene-Acrylic Mixed Resin

The ethylene-acrylic mixed resin is not particularly limited as long as it is one which may be mixed with the core-shell graft copolymer, thereby not only improving the compatibility and the impact strength of the resin composition, but also improving the metallic texture of the molded article by exhibiting the metallic particles on the surface of the molded article to increase a reflective area of the light formed as the appearance of the molded article.

The acrylic-based resin may be a typical resin, for example, a methyl acrylate, an ethyl acrylate, a butyl acrylate, or the like, and is not limited to containing a specific component. Preferably, the acrylic-based resin may be a methyl acrylate having excellent surface roughness. Accordingly, the ethylene-acrylic mixed resin may be an ethylene-methyl acrylate copolymer.

The ethylene-acrylic mixed resin may include an amount of about 15 to 40% by weight of the acrylic-based resin based on 100% by weight of the ethylene-acrylic mixed resin, an amount of about 20 to 35% by weight thereof, or particularly of about 25 to 30% by weight thereof. Further, the ethylene-acrylic mixed resin may suitably include an amount of about 60 to 85% by weight of the ethylene, an amount of about 65 to 80% by weight thereof, or particularly an amount of about 70 to 75% by weight thereof. The ethylene-acrylic mixed resin is required to be within the range to improve the impact strength and the compatibility with the polycarbonate resin and the polyester resin.

The impact reinforcing agent according to the present invention may suitably include an ethylene-acrylic mixed resin: a core-shell graft copolymer at a weight ratio of about 1:0.4 to 10. Preferably, the content of the ethylene-acrylic mixed resin may be an amount of about 1 to 10% by weight based on 100% by weight of the uncoating metallic thermoplastic resin composition, an amount of about 1 to 8% by weight thereof, or particularly an amount of about 2 to 5% by weight. Within this range, toughness and fluidity are excellent.

The uncoating metallic thermoplastic resin composition may include the ethylene-acrylic mixed resin as well as the core-shell graft copolymer in the impact reinforcing agent to contain the ethylene-acrylic mixed resin:the core-shell graft copolymer at weight ratio of about 1:0.4 to 10, thereby not only improving the compatibility and the impact strength of the resin composition, but also improving the metallic texture of the molded article by exhibiting the metallic particles on the surface of the molded article to increase the reflective area of the light formed as the appearance of the molded article.

(4) Metallic Particles

The metallic particles are not particularly limited as long as it may give the metallic texture to the molded article made of the resin composition including the same.

The metallic particles may be used with one type alone or by mixing two or more types. For example, plate-type metallic particles may be used, and spherical-type metallic particles may be further mixed and used. The metallic texture may be degraded by using the spherical-type metallic particles, but a weld line and a flow weld line may be improved.

The material of the metallic particles, which may be used for the metallic appearance required in the molded article to which the resin composition, may suitably include, and for example, any metal or an alloy of any two or more types of metals, and is not limited to a specific component, but preferably, may be an aluminum or an aluminum-based alloy having excellent luminance.

The surface of the metallic particles may be coated or surface treated, and a silica or a silane-based coupling agent may be used as a coating or surface treatment agent, but is not limited thereto.

The content of the metallic particles may be an amount of about 0.1 to 10% by weight based on 100% by weight of the uncoating metallic thermoplastic resin composition, an amount of about 0.5 to 8% by weight thereof, or particularly an amount of about 0.5 to 5% by weight thereof. When the content of the metallic particles is less than about 0.1% by weight, the effect of giving the metallic texture may be insignificant, and when the content of the metallic particles is greater than about 10% by weight, the thermoplastic resin may be decomposed, thereby increasing the amount of gas generated, degrading mechanical properties and moldability, and degrading appearance characteristics due to the weld line or the like.

The average particle diameter of the metallic particle may be about 5 to 100 μm, or particularly of about 10 to 60 μm. When the average particle diameter of the metallic particle is less than 10 μm, the surface area in contact with the resin composition may be too large to cause the decomposition of the resin composition well, thereby increasing the amount of gas generated, and when the average particle diameter of the metallic particle is greater than about 100 μm, the sparkling effect may be increased, and the effect of giving the metallic texture may be insignificant.

Further, the metallic particles may be used by mixing two or more types of metallic particles having different average particle diameters. The mixture of metallic particles may be the mixture of first metallic particles having an average particle diameter of about 5 μm or greater and less than 10 μm and second metallic particles having an average particle diameter of about 10 to 100 μm, or particularly of about 15 to 60 μm. In the mixture of the metallic particles, the content of the first metallic particles may be less than about 3% by weight based on 100% by weight of the resin composition, and the content of the second metallic particles may be less than about 10% by weight based on 100% by weight of the thermoplastic resin composition. As such, the metallic particles may contain the first metallic particles: the second metallic particles at a weight ratio of about 1:0.3 to 10. When the weight ratio is exceeded, the resin composition may be decomposed, thereby increasing the amount of gas generated.

(5) Other Additives

The additive according is not particularly limited as long as it may change the characteristics of the resin composition without significantly changing the properties of the uncoating metallic thermoplastic resin composition according to the present invention.

The additive may include one or more selected from the group consisting of flame retardants, antioxidants, lubricants, release agents, nucleating agents, dispersants, antistatic agents, ultraviolet (UV) stabilizers, pigments, and dyes.

For example, as the antioxidants, the antioxidants such as a phenol-based, a phosphite-based antioxidant, a thioester-based, or a mixture of two or more types of them may be used, and as the lubricants, the lubricants such as a polyethylene-based lubricant, an ethylene-ester-based, an ethylene glycol-glycerin ester-based, a montan-based, an ethylene glycol-glycerin montanic acid-based, an ester-based, or a mixture of two or more types of them may be used. Further, the flame retardants may include one or more compounds selected from a phosphate-based compound, a phosphonate-based compound, a polysiloxane, a phosphazene-based compound, a phosphinate-based compound, or a melamine-based compound as the materials of decreasing combustibility, but are not limited thereto. The release agents, the nucleating agents, the dispersants, the antistatic agents, the ultraviolet stabilizers, the pigment, and the dyes are not particularly limited, and may use commercially available products.

The contents of the other additives are not particularly limited, and may be an amount which may be used to add additional functions in a range which does not impair the target properties of the thermoplastic resin composition.

The contents of the other additives may be 20 parts by weight or less based on total 100 parts by weight of the thermoplastic resin composition, or particularly of about 0.1 to 10 parts by weight thereof. When the contents of the other additives are less than about 0.1 parts by weight, the effect of improving various functions according to the use of the other additives may be insignificant, and when the contents of the other additives is greater than about 10 parts by weight, the mechanical properties may be degraded.

Molded Article Containing Uncoating Metallic Thermoplastic Resin Composition

The molded article may be manufactured by a known method, and for example, the molded article may be manufactured in a pellet form by mixing the aforementioned components and additives, and then melt-extruding the mixture within an extruder.

In an aspect, provided is a molded article which is manufactured by molding the thermoplastic resin composition. The molded article made of the composition may not only maintain the impact strength and the fluidity at an excellent level, but also have improved luminance characteristics (high luminance) and metallic texture, and thus may be used for the molded products in fields where the characteristics of the appearance quality are importantly required, for example, vehicle components, mechanical components, electrical and electronic components, office equipment such as a computer, miscellaneous goods, or the like, and particularly, may be preferably applied to vehicle interior and exterior products such as vehicle bumper components, wheel covers, garnishes, crash pads, panels, and lighting housings.

### Examples 1 to 3 and Comparative Examples 1 to 6: Uncoating Metallic Thermoplastic Resin Composition and Molded Articles Thereof

The polycarbonate resin, the polyester resin, the impact reinforcing agent, and the metallic particles were mixed by a Henschel mixer with the components and contents shown in Table 1 below and dispersed evenly, and then extruded under conditions of the melting temperature of 260° C., the screw rotational speed of 300 rpm, a first vent pressure of about −600 mmHg, and a self-feeding speed of 30 kg/h in a twin-screw melt mixing extruder with L/D=48 and Φ=25 mm. After the extruded strand was cooled in water, the pellets were manufactured by cutting the extruded strand with a rotary cutter, and specimens were manufactured by heat wind drying the manufactured pellets at a temperature of 90 to 100° C. for 4 hours, and then injection-molding the pellets at a temperature of 250 to 270° C.

TABLE 1

| | Examples | | | Comparative Examples | | | | | |
|---|---|---|---|---|---|---|---|---|---|
| Items (% by weight) | 1 | 2 | 3 | 1 | 2 | 3 | 4 | 5 | 6 |
| Polycarbonate resin #1) | 72 | 72 | 72 | 72 | 70.5 | 69 | 78 | 62 | 66 |
| Polyester resin #2) | 20 | 20 | 20 | 20 | 20 | 20 | 20 | 30 | 20 |
| Core-shell graft copolymer | — | 3 | — | 3 | 6 | 6 | — | — | 3 |
| (acrylic-based) #3) | | | | | | | | | |
| Core-shell graft copolymer | — | — | 4.5 | 3 | — | — | — | 6 | — |
| (silicone-based) #4) | | | | | | | | | |
| Ethylene-acrylic-based | 6 | 3 | 1.5 | — | — | — | — | — | 9 |
| mixed resin #5) | | | | | | | | | |
| Metallic particles #6) | 2 | 2 | 2 | 2 | 2 | 2 | 2 | 2 | 2 |
| Dispersant | — | — | — | — | 1.5 | 3 | — | — | — |

#1) A polycarbonate thermoplastic resin (TRILOY 3020PJ, Samyang Co.) having a viscosity average molecular weight of 19,000 was used.
#2) A polybutylene terephthalate resin (TRILOY 1700S, Samyang Co.) having an intrinsic viscosity of 1.1 dl/g was used.
#3) An ethyl methyl acrylate copolymer having a specific gravity of 0.95 g/cm³ (ASTM D792) and melt Index 3 g/10 min (ASTM D1238) was used.
#4) A copolymer in which a methylmethacrylate monomer was grafted to a rubber made of a dimethylsiloxane and a butyl acrylate having average particle diameters of 0.1 to 1 micrometer was used.
#5) An Elvaloy 1330AC (ethylene methyl acrylate copolymer) from Dupont Co. was used.
#6) Aluminum particles from Eckart Co. shaped like an amorphous plate and having an average particle diameter of 16 μm were used.

Method for Measuring Properties

(1) Metallic Texture

The flop index was measured using a BYK-Mac i Spectrophotometer of BYK Co. Specifically, the flop index was calculated by measuring the luminance of reflected light at angles of 15°, 45°, and 110° with respect to the surface of the injection specimen manufactured in the Examples and the Comparative Examples, and then substituting the luminance into Equation 1.

$$\begin{matrix}[ Equation 1 ] & \\ Flop Index = \frac{2.69 {( {L}_{15 °}^{*} - {L}_{110 °}^{*} )}^{1.11}}{{( {L}_{45 °}^{*} )}^{0.86}} & Equation 1\end{matrix}$$

L*15°=luminance of the reflected light measured at an angle of 15°

L*45°=luminance of the reflected light measured at an angle of 45°

L*115°=luminance of the reflected light measured at an angle of 115°

The flop index of the object surface without metallic texture is zero; the flop index of the actual metal surface is 15 to 17; the flop index of the surface of the injection-molded article coated with the coating composition is 12 to 14; and the flop index of a surface on which the metallic texture may be visually felt is 6 or more.

(2) Dispersibility

The dispersibility of the metallic particles of the injection specimens manufactured through the thermoplastic resin compositions of the Examples 1 to 6 and the Comparative Examples 1 to 6 was measured using the BYK-Mac i Spectrophotometer of BYK Co. As the dispersibility value is lower, the dispersibility of the metallic particles is represented as being higher.

(3) Luminance (Gloss Level)

Luminance was measured by a gloss level at an angle of 60° using a micro-TRI-gloss digital variable glossmeter of BYK Co.

(4) Flow Index (MI)

After drying at a temperature of 90° C. for 4 hours in the pellet state based on ASTM D1238, the amount of flowing for 10 minutes under conditions at a temperature of 250° C. and 5 kg load was measured.

(5) IZOD Impact Characteristics

The impact strength (⅛″ thick Izod Notched type) was measured based on ASTM D256 with respect to the injection specimens manufactured in the Examples and the Comparative Examples.

(6) Tensile Strength

The tensile strength was measured based on ASTM D638 with respect to the injection specimens manufactured in the Examples and the Comparative Examples.

### Experimental Example—Comparison of Appearance Characteristics and Mechanical Properties of Molded Articles According to the Examples and the Comparative Examples

TABLE 2

| | | Examples | | | Comparative Examples | | | | | |
|---|---|---|---|---|---|---|---|---|---|---|
| Items (unit) | | 1 | 2 | 3 | 1 | 2 | 3 | 4 | 5 | 6 |
| Appearance | Metallic texture | 13.6 | 13.5 | 13.0 | 10.3 | 11.1 | 11.3 | 11.2 | 9.7 | 13.7 |
| Characteristics | (flop index) | | | | | | | | | |
| | Dispersibility | 3.92 | 3.89 | 3.98 | 4.14 | 4.05 | 4.02 | 4.11 | 4.24 | 3.88 |
| | Luminance (gloss | 90 | 90 | 89 | 88 | 89 | 89 | 88 | 85 | 91 |
| | level) | | | | | | | | | |
| Mechanical | Flow index (MI) | 29 | 26 | 24 | 20 | 23 | 27 | 35 | 22 | 33 |
| properties | Impact strength | 12 | 14 | 17 | 17 | 13 | 10 | 5 | 14 | 16 |
| | (kgf*cm/cm) | | | | | | | | | |
| | Tensile strength | 633 | 631 | 628 | 630 | 631 | 630 | 685 | 630 | 582 |
| | (kgf/cm²) | | | | | | | | | |

As shown in Tables 1 and 2, the resin composition according to the Examples showed a state where all measured characteristics were excellently balanced. In the case of the metallic texture test (Flop index), the Flop index value of 13 or more was shown in all compositions containing the ethylene-acrylic mixed resin, and excellent luminance characteristics of 90 or greater were shown. Further, the high tensile strength of 630 or greater was maintained, and excellent fluidity and impact strength were implemented. On the other hand, the compositions in the Comparative Examples showed the unbalanced characteristics as compared to the Examples in the metallic texture, the luminance, the tensile strength, the fluidity, and the impact strength, and it was confirmed that the unbalanced characteristics could significantly degrade various characteristics of the final product.

As a result, the uncoating metallic thermoplastic resin composition according to various exemplary embodiments of the present invention mixes each component containing the metallic particles at an appropriate ratio, such that the molded article made of the composition may not only improve the luminance characteristics (high luminance) and the metallic texture, but also implement the characteristic of maintaining the impact strength and the fluidity at an excellent level.

What is claimed is:

1. An uncoating metallic thermoplastic resin composition comprising:
an amount of 20 to 80% by weight of a polycarbonate resin;
an amount of 5 to 50% by weight of a polyester resin;
an amount of 5 to 20% by weight of an impact reinforcing agent; and
an amount of 0.1 to 10% by weight of a metallic particle,
the % by weight based on the total weight of the uncoating metallic thermoplastic resin composition,
wherein the impact reinforcing agent comprises one or more selected from a core-shell graft copolymer and an ethylene-acrylic mixed resin.

2. The uncoating metallic thermoplastic resin composition of claim 1,
wherein the polycarbonate resin has a viscosity average molecular weight (Mv) of 15,000 to 40,000 (25° C. methylene chloride solution).

3. The uncoating metallic thermoplastic resin composition of claim 1,
wherein the polyester resin has an intrinsic viscosity [η] of 0.85 to 1.52 dl/g.

4. The uncoating metallic thermoplastic resin composition of claim 1,
wherein the core-shell graft copolymer comprises one or more monomers selected from unsaturated compounds consisting of C1-C8 methacrylic acid alkyl esters, C1-C8 methacrylic acid esters, maleic anhydride, and C1-C4 alkyl or phenyl nuclear-substituted maleimides with a core of rubber-based polymer which is manufactured by polymerizing one or more selected from the group consisting of a C4-C6 diene-based rubber, an acrylate-based rubber, and a silicone-based rubber monomer.

5. The uncoating metallic thermoplastic resin composition of claim 1,
wherein the ethylene-acrylic mixed resin comprises an amount of 15 to 40% by weight of an acrylic-based resin, and an amount of 60 to 85% by weight of an ethylene, based on 100% by weight of the ethylene-acrylic mixed resin.

6. The uncoating metallic thermoplastic resin composition of claim 1,
wherein the impact reinforcing agent comprises the ethylene-acrylic mixed resin: the core-shell graft copolymer at a weight ratio of 1:0.4 to 10.

7. The uncoating metallic thermoplastic resin composition of claim 1,
wherein the metallic particle comprises one or more selected from the group consisting of aluminum and an aluminum-based alloy.

8. The uncoating metallic thermoplastic resin composition of claim 1,
wherein an average particle diameter of the metallic particle is 5 to 100 μm.

9. The uncoating metallic thermoplastic resin composition of claim 8,
wherein the metallic particle comprises one or more selected from the group consisting of a first metallic particle which has the average particle diameter of 5 μm or greater and less than 10 μm, and a second metallic particle which has the average particle diameter of 10 to 100 μm.

10. The uncoating metallic thermoplastic resin composition of claim 9,
wherein the metallic particle comprises the first metallic particle: the second metallic particle at a weight ratio of 1:0.3 to 10.

11. The uncoating metallic thermoplastic resin composition of claim 1, further comprising additives comprising one or more selected from the group consisting of flame retardants, antioxidants, lubricants, release agents, nucleating agents, dispersants, antistatic agents, ultraviolet (UV) stabilizers, pigments, and dyes.

12. A molded article comprising the uncoating metallic thermoplastic resin composition of claim 1.

13. A vehicle comprising a molded article of claim 12.
